(19) United States
(12) Patent Application Publication
(10) Pub. No.: US 2025/0132074 A1
(43) Pub. Date: Apr. 24, 2025

(54) CHIP RESISTOR

(71) Applicant: KOA CORPORATION, Ina-shi (JP)

(72) Inventor: Taro KIMURA, Ina-shi (JP)

(73) Assignee: KOA CORPORATION, Ina-shi (JP)

(21) Appl. No.: 18/896,541

(22) Filed: Sep. 25, 2024

(30) Foreign Application Priority Data
Oct. 23, 2023 (JP) 2023-181902

(51) Int. Cl. H01C 7/18; H01C 1/01; H01C 1/14

(52) U.S. Cl. CPC H01C 7/18; H01C 1/01; H01C 1/14

(57) ABSTRACT

A chip resistor 1, which is excellent in the surge characteristics and also suitable for miniaturization, is formed by printing into a crank shape, and a first area S1 surrounded by a parallelogram is a portion where a large amount of current flows while two second areas S2a, S2b located outside the first area S1 are portions with small current distributions. A trimming groove 12 for adjustment of a resistance value is formed into an L-cut shape as a whole such that it has a coarse adjustment portion 12a formed to pass through the second area S2a and extend into the first area S1 and a fine adjustment portion 12b formed to pass through the first area S1 from the distal end of the coarse adjustment portion 12a and extend to a position reaching the second area S2a again.

### TECHNICAL FIELD

The present invention relates to a chip resistor in which a trimming groove is formed on a resistor for the purpose of adjustment of a resistance value.

### BACKGROUND ART

A chip resistor is formed to mainly include a rectangular parallelepiped insulating substrate, a pair of front electrodes placed on the front surface of the insulating substrate to face each other with a predetermined space being interposed therebetween, a pair of back electrodes placed on the back surface of the insulating substrate to face each other with a predetermined space being interposed therebetween, end face electrodes that bridge the front electrodes and the back electrodes, a resistor that bridges the pair of front electrodes, and a protective film for covering the resistor.

In common cases, for producing a chip resistor of this type, electrodes, resistors, protective films, and the like for a plurality of chip resistors are collectively formed on a large-sized substrate having a sheet-like shape, and then the large-sized substrate is divided along grid-like division lines (for example, division grooves) to obtain multi-piece chip resistors. In the processes of producing a chip resistor of this type, a plurality of chip resistors is formed by printing a resistance paste on one of the surfaces of the large-sized substrate and sintering the printed paste, which, however, inevitably causes the slight variations in size and film thickness among the resistors due to the positional deviation and/or bleeding during printing or the influence of temperature unevenness in a sintering furnace, and thus requires the process of forming a trimming groove on each resistor which is in the state of being on the large-sized substrate to adjust and set a desired resistance value.

However, when a surge voltage generated due to a static electricity, power supply noise, or the like is applied to the chip resistor formed as above, an excessive electrical stress is caused and thus the characteristics of the resistor is affected, which may lead to destroy of the resistor in the worst scenarios. For improving the surge characteristics, it has been known that making the total length of the resistor long by forming it into a meandering shape enables the potential drop to be smoothed.

For example, Patent Literature 1 proposes a chip resistor formed in such a manner that, a chip resistor having a meandering shape is formed by printing on the main surface of the insulating substrate, then trimming grooves extending straight from the opposite sides of the resistor are formed in the directions opposite to each other, and making these two trimming grooves extend to the position where the distal ends thereof intersect with each other. In the chip resistor formed described above, the resistor meanders near the distal ends of the two trimming grooves so as to make the entire length long.

In the chip resistor formed as described above, the two trimming grooves extending straight relative to the resistor are provided in the 180 degrees opposite directions, which causes the main current path of the resistor to change its direction 180 degrees at the portion where the distal ends of the two trimming grooves intersect each other. This enables the entire length of the resistor formed by printing to be lengthened and thus the surge characteristics to be improved.

### CITATION LIST

### Patent Literature

Patent Literature 1: JP-A-2006-19694

### SUMMARY OF INVENTION

### Technical Problem

However, in the chip resistor in which the distal ends of the two trimming grooves are arranged to intersect each other to make the current path turn 180 degrees as disclosed in the prior art such as Patent Literature 1, microcracks are generated at the distal ends of the two trimming grooves, in other words, the microcracks are generated at the turn portion where the loads are concentrated. Accordingly, application of a high voltage to the resistor which may cause the local temperature rise results in a risk of destroy of the resistor. In particular, in a small chip resistor having a small substrate area, the width dimension of the resistor becomes much narrower as the entire length of the resistor increases due to formation of the trimming grooves, which increases the current per unit area (current density) if being used under the large power load. This leads to a problem that the resistor cannot withstand the load and may be easily destroyed.

The present invention has been made in view of the circumstances described above of the prior art, and an object thereof is to provide a chip resistor which is excellent in the surge characteristics and also suitable for miniaturization.

### Solution to Problem

In order to achieve the object described above, the present invention provides a chip resistor comprising: an insulating substrate having a rectangular parallelepiped shape; a first front electrode and a second front electrode arranged to face each other at both end portions of the insulating substrate with a space having a certain width being interposed therebetween; and a resistor arranged in the space to bridge between the first front electrode and the second front electrode, the resistor being provided with one trimming groove so as to adjust a resistance value, wherein the resistor includes a first resistor portion having a rectangular shape, a second resistor portion having a rectangular shape, and a third resistor portion, the first resistor portion being formed to extend parallel to the first front electrode and second front electrode, the second resistor portion being formed to be connected to one side portion of the first resistor portion via a first leading portion connected to the first front electrode, and the third resistor portion being formed to be connected to another side portion of the first resistor portion via a second leading portion connected to the second front electrode, and where, within the resistor, an area surrounded by a parallelogram having the first leading portion and the second leading portion as opposite sides is defined as a first area and each of two areas having a triangular shape located outside the first area is defined as a second area, the trimming groove includes a coarse adjustment portion and a fine adjustment portion, the coarse adjustment portion being formed to extend straight from one of mutually opposing outer edges of the first resistor portion as a start end point toward another one of the outer edges, pass through the second area, and reach at least the first area, and the fine adjustment portion being formed to extend from a distal end of the coarse adjustment portion in an orthogonal direction, pass through at least the first area, and reach the second area again.

In the chip resistor formed as described above, forming the resistor including the first resistor portion, the second resistor portion, and the third resistor portion into a crank shape as a whole enables the entire length of the resistor to be ensured, and as a result, can provide stable surge characteristics. In the resistor formed as described above, the first area is a portion where a large amount of current flows while the second areas are portions with small current distributions. In the present invention, the trimming groove for adjustment of a resistance value is formed into an L-cut shape such that it extends from the second area, passes through the first area, and reaches the second area again, thereby allowing the portion where microcracks are generated to be separated from the current path where loads are concentrated. Moreover, the main current path after adjustment of a resistance value can be made long without involving a turn portion, thereby reducing the adverse effect on the characteristics caused by the microcracks and also further improving the surge characteristics.

In the chip resistor formed as described above, the distal end position of the coarse adjustment portion, which is a bent portion of the trimming groove, is set within the first area, whereby the widthwise dimension of the first resistor portion that narrows with the amount of cutting of the coarse adjustment portion is limited to some extent. This prevents the resistance width of the resistor from becoming extremely narrow, and thus even enables the reduced size chip resistor to adapt to high power. The coarse adjustment portion of the trimming groove may extend beyond the first area to a position reaching the second area, and in this case, the coarse adjustment portion may be formed to extend from the one second area to the other second area beyond the first area, and then the fine adjustment portion may be formed to extend from the distal end of the coarse adjustment portion in the other second area to the one second area beyond the first area.

Furthermore, in the chip resistor formed as described above, where the length of the outer edge of the first resistor portion is defined as L, setting the start end portion of the trimming groove within a range from the first leading portion of the second resistor portion or the second leading portion of the third resistor portion to L/2 enables the current path after adjustment of a resistance value to be long, which is preferable.

### Advantageous Effects of Invention

According to the present invention, it is possible to provide a chip resistor which is excellent in the surge characteristics and also suitable for miniaturization.

### BRIEF DESCRIPTION OF DRAWINGS

FIG. 1 is a top view of a chip resistor according to the first embodiment of the present invention.

FIG. 2 is a cross-sectional view along the line II-II of FIG. 1.

FIGS. 3A and 3B are diagrams for explaining a resistor provided in the chip resistor of FIG. 1.

FIG. 4 is a top view of a chip resistor according to the second embodiment of the present invention.

### DESCRIPTION OF EMBODIMENTS

Hereinafter, an embodiment of the present invention will be described with reference to the drawings.

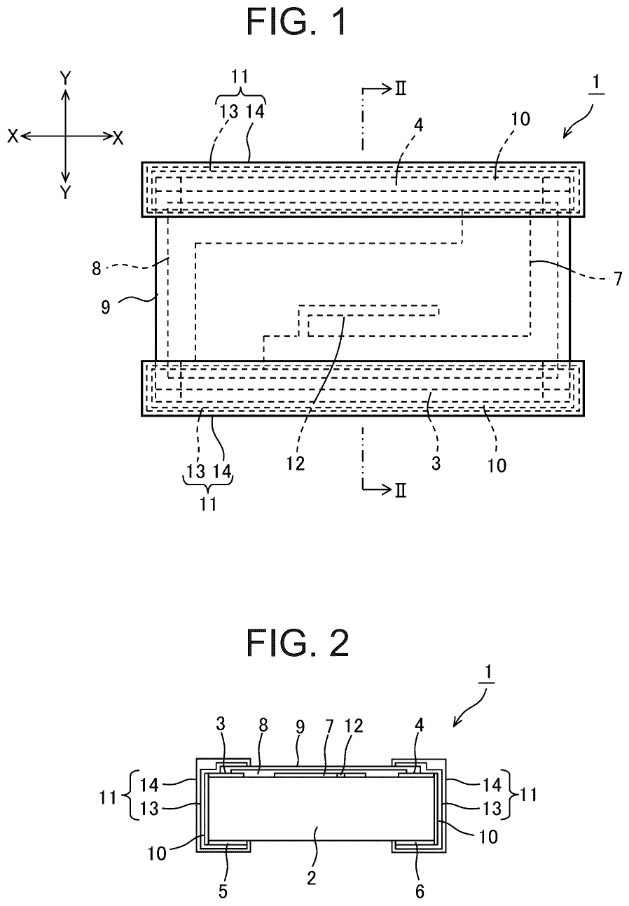

FIG. 1 is a top view of a chip resistor according to the first embodiment of the present invention, and FIG. 2 is a cross-sectional view along the line II-II of FIG. 1.

As illustrated in FIG. 1 and FIG. 2, a chip resistor 1 according to the first embodiment is formed to mainly include a rectangular parallelepiped insulating substrate 2, a first front electrode 3 and a second front electrode 4 which are provided at both the end portions in the short-side direction on the front surface of the insulating substrate 2, a first back electrode 5 and a second back electrode 6 which are provided at both the end portions in the short-side direction on the back surface of the insulating substrate 2, a resistor 7 provided so as to electrically connect between the pair of the first front electrode 3 and the second front electrode 4, an undercoat layer 8 provided so as to cover the resistor 7, an overcoat layer 9 provided so as to cover the undercoat layer 8, a pair of end face electrodes 10 provided on both the end faces in the short-side direction of the insulating substrate 2, and a pair of external electrodes 11 provided so as to cover the end face electrodes 10. In the following, the longitudinal direction of the insulating substrate 2 (left and right direction in FIG. 1) is defined as the X-axis, and the short-side direction of the insulating substrate 2 (vertical direction in FIG. 1) is defined as the Y-axis.

The insulating substrate 2 is obtained in such a manner that a sheet-shaped large substrate is divided along a primary division groove and a secondary division groove which extend in the vertical direction and the horizontal direction to obtain a plurality of substrates. The insulating substrate 2 is a ceramic substrate mainly containing alumina.

The first front electrode 3 and the second front electrode 4 are obtained by screen-printing an Ag paste mainly containing Ag (silver) and then drying and sintering the printed paste. The first front electrode 3 and the second front electrode 4 are formed on the front surface of the insulating substrate 2 along the long sides thereof, with a space having a certain width being interposed therebetween in the short-side direction (Y-axis direction).

The first back electrode 5 and the second back electrode 6 are obtained by screen-printing an Ag paste and drying and sintering the printed paste. The first back electrode 5 and the second back electrode 6 are formed on the back surface of the insulating substrate 2 along the long sides thereof, with a space having a certain width being interposed therebetween in the short-side direction.

The resistor 7 is obtained by screen-printing a resistor paste such as ruthenium oxide and drying and sintering the printed paste. As will be described in detail later, forming one trimming groove 12 in the resistor 7 allows an initial resistance value of the resistor 7 that has been formed by printing to be adjusted to a target resistance value.

The undercoat layer 8 is obtained by screen-printing a glass paste and drying and sintering the printed paste. The undercoat layer 8 is formed so as to cover the resistor 7 as a whole before formation of the trimming groove 12.

The overcoat layer 9 is obtained by screen-printing a resin paste such as an epoxy resin or a phenol resin and heating and curing the printed paste. The overcoat layer 9 is formed so as to cover the undercoat layer 8 as a whole after formation of the trimming groove 12.

The pair of end face electrodes 10 is formed by sputtering Ni—Cr or the like. The pair of end face electrodes 10 electrically connects between the first front electrode 3 and the first back electrode 5 and between the second front electrode 4 and the second back electrode 6, which are separated apart from each other via the end faces of the insulating substrate 2.

The pair of external electrodes 11 has a double layer structure including a barrier layer 13 provided inside and an external connection layer 14 provided outside. The barrier layer 13 is an Ni plating layer formed by electrolytic plating and the external connection layer 14 is an Sn plating layer formed by electrolytic plating.

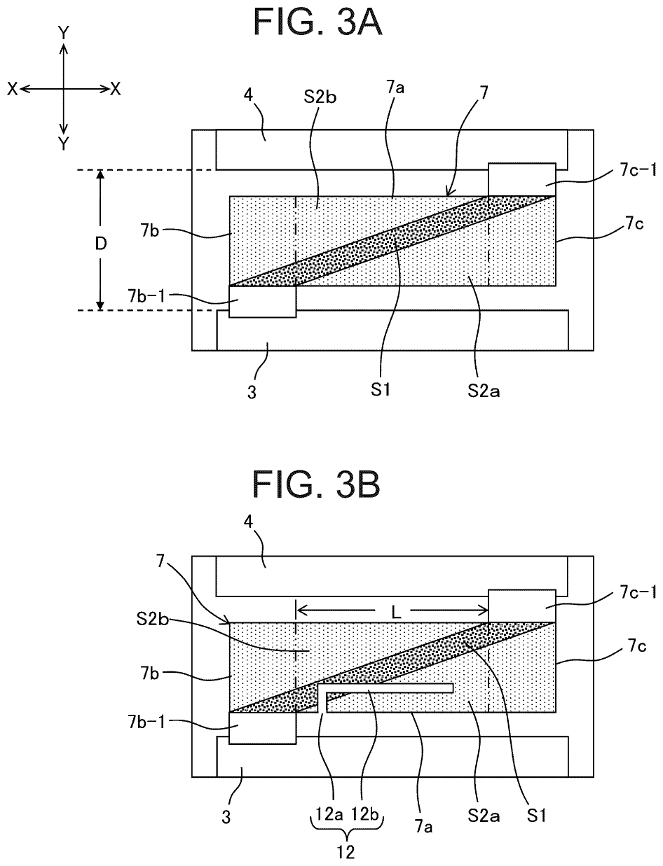

FIG. 3 is a diagram for explaining the resistor 7 provided in the chip resistor 1, in particular, FIG. 3(A) illustrates a state of the resistor 7 before being provided with the trimming groove 12 and FIG. 3(B) illustrates a state of the resistor 7 after being provided with the trimming groove 12.

As illustrated in FIG. 3(A), the first front electrode 3 and the second front electrode 4 are arranged at both the end portions in the short-side direction on the front surface of the insulating substrate 2 so as to face each other with a space D having a certain width being interposed therebetween, and the resistor 7 is formed by printing in the space D so as to electrically connect between the first front electrode 3 and the second front electrode 4. The resistor 7 includes a first resistor portion 7a, a second resistor portion 7b, and a third resistor portion 7c. The first resistor portion 7a having a rectangular shape is arranged in the center of the space D and extends parallel to the first front electrode 3 and the second front electrode 4 (in the X-axis direction). The second resistor portion 7b having a rectangular shape extends from a first leading portion 7b-1 connected to the first front electrode 3 to the middle of the space D in the Y-axis direction and is connected to the side portion of the first resistor portion 7a which is illustrated in the left of FIG. 3A. The third resistor portion 7c extends from a second leading portion 7c-1 connected to the second front electrode 4 to the middle of the space D in the Y-axis direction and is connected to the side portion of the first resistor portion 7a which is illustrated in the right of FIG. 3A.

The resistor 7 thus formed by printing has a crank-shape which is point symmetrical relative to the center of the first resistor portion 7a. Forming the resistor 7 into the crank-shape increases the entire length of the resistor 7 and thus provides the stable surge characteristics. In the resistor 7 formed as described above, within a current path from the first front electrode 3 toward the second front electrode 4, a main current path through which the current flows the most is a straight path passing through the center of the first resistor portion 7a from the first leading portion 7b-1 of the first front electrode 3 and extending to the second leading portion 7c-1 of the second front electrode 4. That is, within the resistor 7, where an area surrounded by a parallelogram having the first leading portion 7b-1 and the second leading portion 7c-1 as opposite sides is defined as a first area S1 and two areas having triangular shapes located outward across the first area S1 are defined as second areas S2a, S2b, the first area S1 is a portion through which a large amount of current flows while the two second areas S2a, S2b are portions with small current distributions.

As illustrated in FIG. 3(B), forming one trimming groove 12 on the crank-shaped resistor 7 allows the initial resistance value after the resistor 7 is formed by printing to be adjusted to a target resistance value.

The trimming groove 12 includes a coarse adjustment portion 12a and a fine adjustment portion 12b, and is formed in an L-cut shape as a whole. The coarse adjustment portion 12a extends straight in the upward direction on the Y-axis, starting from the lower side of the first resistor portion 7a. The fine adjustment portion 12b is bent at right angles from the distal end of the coarse adjustment portion 12a and extends straight in the rightward direction on the X-axis. Here, the coarse adjustment portion 12a passes through the second area S2a that is in contact with the lower side of the first resistor portion 7a and extends into the first area S1, and the fine adjustment portion 12b passes through the first area S1 from the distal end of the coarse adjustment portion 12a and extends to a position reaching the second area S2a again.

The coarse adjustment portion 12a of the trimming groove 12 is formed to extend to a position reaching the first area S1, starting from the second area S2a having a small current distribution in the resistor 7 as a start end position. With this structure, extending the coarse adjustment portion 12a in the Y-axis direction to increase the amount of cutting thereof causes the width dimension of the first resistor portion 7a to be narrowed, and thus enables the coarse adjustment of the resistance value. On the other hand, the fine adjustment portion 12b of the trimming groove 12 is formed to extend from the first area S1, in which the distal end of the coarse adjustment portion 12a is located, toward the second area S2a having a less current distribution again, which makes the ratio of an increment of a resistance value relative to an increment of the amount of cutting of the fine adjustment portion 12b small. With this structure, extending the fine adjustment portion 12b in the X-axis direction to increase the amount of cutting thereof enables the resistance value to be preciously and finely adjusted. Furthermore, arranging the distal end of the trimming groove 12 formed into the L-cut shape within the second area S2a allows the portion where the microcracks are generated to be separated from the current path where the loads are concentrated. Here, extending the distal end of the trimming groove 12 to the third resistor portion 7c allows the portion where the microcracks are generated to be further separated from the current path, thereby further reducing the adverse effect of the microcracks.

Still further, in the resistor 7 in which the resistance value has been adjusted by providing the trimming groove 12, within the current path from the first front electrode 3 to the second front electrode 4, the main current path where the current flows the most is a bent path passing through the corner portion of the trimming groove 12 (the distal end of the coarse adjustment portion 12a) from the first leading portion 7b-1 of the first front electrode 3 and extending toward the second leading portion 7c-1 of the second front electrode 4. The bent main current path is longer than the straight main current path of the resistor 7 before the resistance value is adjusted. Thus, providing the trimming groove 12 further improves the surge characteristics that have been secured by printing and forming the resistor 7 into the crank shape.

The start end position of the trimming groove 12 in the second area S2a is not particularly limited, however, where the length of the outer edge of the first resistor portion 7a along the X-axis direction thereof is defined as L, the start end position of the trimming groove 12 is set within a range from the first leading portion 7b-1 of the second resistor portion 7b to L/2.

The trimming groove 12 may be formed starting from the upper side of the first resistor portion 7a as the start end position, instead of the lower side of the first resistor portion 7a. In this case, the coarse adjustment portion 12a may be formed to pass through the second area S2b that is in contact with the upper side of the first resistor portion 7a and extend to a position reaching the first area S1, and then the fine adjustment portion 12b may be formed to pass through the first area S1 from the distal end of the coarse adjustment portion 12a and extend to a position reaching the second area S2b again. In this process, the start end position of the trimming groove 12 within the second area S2b is set within a range from the second leading portion 7c-1 of the third resistor portion 7c to L/2.

As described above, in the chip resistor 1 according to the first embodiment, the resistor 7 formed by printing in the space D between the first front electrode 3 and the second front electrode 4 includes the first resistor portion 7a having a rectangular shape, which is arranged in a center portion of the gap D and extends parallel to the first front electrode 3 and second front electrode 4, the second resistor portion 7b having a rectangular shape, which extends from the first leading portion 7b-1 connected to the first front electrode 3 to the middle of the space D in the Y-axis direction and is connected to the side portion of the first resistor portion 7a, and the third resistor portion 7c which extends from the second leading portion 7c-1 connected to the second front electrode 4 to the middle of the space D in the Y-axis direction and is connected to the side portion of the first resistor portion 7a. Forming the resistor 7 by printing as described above to have a crank shape as a whole enables the entire length of the resistor 7 to be ensured, and as a result, can provide stable surge characteristics.

In the resistor 7 formed to have a crank shape, the first area S1 surrounded by a parallelogram having the first leading portion 7b-1 and the second leading portion 7c-1 as opposite sides is a portion where a large amount of current flows while the two triangular second areas S2a, S2b located outside across the first area S1 are portions with small current distributions. In the present embodiment, the trimming groove 12 for adjustment of the resistance value is formed into an L-cut shape such that it extends from the second area S2a or the second S2b, passes through the first area S1, and extends to the second area S2a or the second S2b again, thereby allowing the portion where microcracks are generated to be separated from the current path where loads are concentrated. Moreover, the main current path after adjustment of a resistance value can be made long without involving a turn portion, thereby reducing the adverse effect on the characteristics caused by the microcracks and also further improving the surge characteristics.

Furthermore, the distal end position of the coarse adjustment portion 12a, which is a bent portion of the trimming groove 12, is set within the first area S1, whereby the widthwise dimension of the first resistor portion 7a that narrows with the amount of cutting of the coarse adjustment portion 12a is limited to some extent. This prevents the resistance width of the resistor 7 from becoming extremely narrow, and thus even enables the reduced size chip resistor 1 to adapt to high power.

Still further, where the length of the outer edge of the first resistor portion 7a along the X-axis direction thereof is defined as L, the start end portion of the trimming groove 12 is set within a range from the first leading portion 7b-1 of the second resistor portion 7b or the second leading portion 7c-1 of the third resistor portion 7c to L/2. This can make the current path after adjustment of a resistance value long.

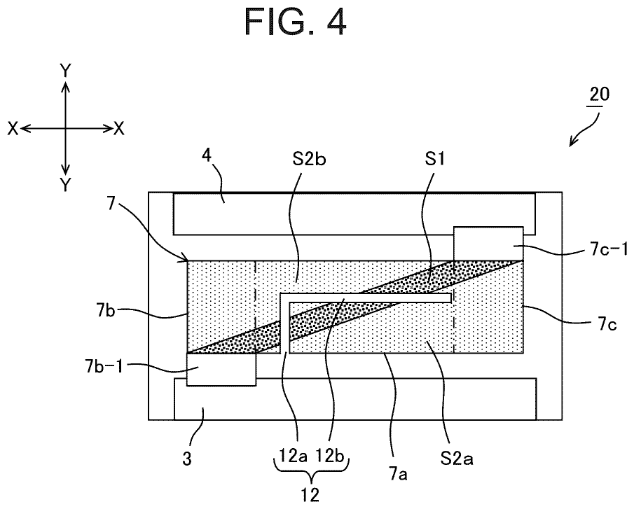

FIG. 4 is a top view of a chip resistor 20 according to the second embodiment of the present invention. The features corresponding to those illustrated in FIG. 1 to FIG. 3 are provided with the same reference signs, and the repetitive therefor will be omitted.

In the chip resistor 20 according to the second embodiment, the trimming groove 12 for adjustment of a resistance value formed in the resistor 7 includes the coarse adjustment portion 12a formed to pass through the first area S1 from the one second area S2a and extend in the upward direction on the Y-axis to the other second area S2b, and the fine adjustment portion 12b formed to pass through the first area S1 from the distal end of the coarse adjustment portion 12a located within the second area S2b and extend in the rightward direction on the X-axis to reach the one second area S2a again. The other features are generally the same as those of the chip resistor 1 according to the first embodiment.

In the second embodiment as well, the trimming groove 12 can be formed starting from the upper side of the first resistor portion 7a as the start end position. In this case, the coarse adjustment portion 12a may be formed to pass through the first area S1 from the other second area S2b and extend in the downward direction on the Y-axis to reach the one second area S2a, and then the fine adjustment unit 12b may be formed to pass through the first area S1 from the one second area S2a and extend in the leftward direction on the X-axis to reach the other second area S2b again.

In the chip resistor 20 according to the second embodiment formed as described above, forming the resistor 7 by printing to have a crank shape enables the entire length of the resistor 7 to be ensured, and as a result, can provide stable surge characteristics. Furthermore, the trimming groove 12 for adjustment of a resistance value is formed into an L-cut shape such that it includes the fine adjustment portion 12a formed to pass through the first areas S1 from either one of the second areas (S2a or S2b) and extend to the other one of the second areas (S2a or S2b) and the fine adjustment portion 12b formed to pass through the first area S1 from the other one of the second areas (S2a or S2b) and extend to the one of the second areas (S2a or S2b) again, whereby the portion where microcracks are generated can be separated from the current path where loads are concentrated. Moreover, the main current path after adjustment of a resistance value can be made long without involving a turn portion, thereby reducing the adverse effect on the characteristics caused by the microcracks and also further improving the surge characteristics.

The present invention is not limited to the embodiments described above, and various modifications can be made as long as not departing from the gist of the present invention. All the technical matters involved in the technical idea according to the scope of claims are included in the present invention. The preferred embodiments have been exemplified herein, and those skilled in the art could realize various alternatives, modifications, variations, and improvements based on the disclosure, which fall within the scope of the claims of the present invention.

For example, in each of the embodiments described above, the first front electrode 3, the second front electrode 4, the first back electrode 5, and the second back electrode 6 are formed along the long sides of the insulating substrate 2, respectively, however, they may be formed along the short sides of the insulating substrate 2.

### REFERENCE SIGNS LIST

1, 20 chip resistor
2 insulating substrate
3 first front electrode
4 second front electrode
5 first back electrode
6 second back electrode
7 resistor
7a first resistor portion
7b second resistor portion
7b-1 first leading portion
7c third resistor portion
7c-1 second leading portion
8 undercoat layer
9 overcoat layer
10 end face electrode
11 external electrode
12 trimming groove
12a coarse adjustment portion
12b fine adjustment portion
13 barrier layer
14 external connection layer
D space
S1 first area
S2a, S2b second area

1. A chip resistor comprising:
an insulating substrate having a rectangular parallelepiped shape;
a first front electrode and a second front electrode arranged to face each other at both end portions of the insulating substrate with a space having a certain width being interposed therebetween; and
a resistor arranged in the space to bridge between the first front electrode and the second front electrode,
the resistor being provided with one trimming groove so as to adjust a resistance value,
wherein
the resistor includes a first resistor portion having a rectangular shape, a second resistor portion having a rectangular shape, and a third resistor portion, the first resistor portion being formed to extend parallel to the first front electrode and second front electrode, the second resistor portion being formed to be connected to one side portion of the first resistor portion via a first leading portion connected to the first front electrode, and the third resistor portion being formed to be connected to another side portion of the first resistor portion via a second leading portion connected to the second front electrode, and
where, within the resistor, an area surrounded by a parallelogram having the first leading portion and the second leading portion as opposite sides is defined as a first area and each of two areas having a triangular shape located outside the first area is defined as a second area,
the trimming groove includes a coarse adjustment portion and a fine adjustment portion, the coarse adjustment portion being formed to extend straight from one of mutually opposing outer edges of the first resistor portion as a start end point toward another one of the outer edges, pass through the second area, and reach at least the first area, and the fine adjustment portion being formed to extend from a distal end of the coarse adjustment portion in an orthogonal direction, pass through at least the first area, and reach the second area again.

2. The chip resistor according to claim 1, wherein
the distal end of the coarse adjustment portion is located within the first area.

3. The chip resistor according to claim 1, wherein
where a length of each of the outer edges of the first resistor portion is defined as L, the start end portion of the trimming groove is set within a range from the first leading portion or the second leading portion to L/2.

4. The chip resistor according to claim 1, wherein
a distal end of the fine adjustment portion is located within the third area.
